(19) United States
(12) Patent Application Publication
(10) Pub. No.: US 2009/0049232 A1
(43) Pub. Date: Feb. 19, 2009

(54) EXECUTE-IN-PLACE IMPLEMENTATION FOR A NAND DEVICE

(76) Inventors: Sandeep BRAHMADATHAN, Trichur (IN); Bikram Banerjee, Jadaypur (IN)

Correspondence Address: EVERGREEN VALLEY LAW GROUP, 2670 S. WHITE ROAD, SUITE 275, SAN JOSE, CA, 95148, US

(21) Appl. No.: 11/840,217

(22) Filed: Aug. 17, 2007

(51) Int. Cl. G06F 12/00

(52) U.S. Cl. 711/103; 711/E12.001

(57) ABSTRACT

An Execute-In-Place (XIP) implementation in a NAND controller of the kind that controls a NAND flash memory device. A page load command is provided to a predefined block and page address in a NAND device and identifies whether the boot read request received from the processor is a continuation of a previous boot read request. A read enable pin in the NAND device is toggled if the boot read request is a continuation of the previous boot read request. A random data output command sequence is sent to the NAND device and the read enable pin is toggled if the boot read request is not a continuation of the previous boot read address.

### BACKGROUND

Embodiments of the invention relate generally to a NAND memory system and more particularly to Execute-In-Place (XIP) implementation in a NAND controller of a NAND system.

XIP refers to the ability of a processor to execute a program directly from a memory device coupled to the processor. In general, traditional XIP has not been supported in NAND flash memory devices. However, partial XIP for booting purposes is made possible by issuing a load command to a pre-defined block and page address during an initial power-up sequence of a NAND memory controller and reading the required data from a page buffer in a NAND device.

FIG. 1 is a block diagram of a NAND system 100 according to prior art. The NAND system 100 includes a NAND device 105 and a NAND controller 110. The NAND controller 110 includes an engine 125 that performs address translation and random data output functions and a programmable command sequencer 120 that performs a power-up sequence function. The engine 125 and the programmable command sequencer 120 are coupled to a NAND device interface 115. The NAND device interface 115 is coupled to the NAND device 105.

Upon application of power, the programmable command sequencer 120 performs an initial power-up sequence. During this sequence a processor (not shown) issues to the engine 125 a boot read request for desired boot code. When the programmable command sequencer 120 finishes its power-up sequence, it issues a “page load” command, causing the NAND device 105 to load into its page buffer a page of code in which the desired boot code resides. The engine 125 then issues a “random data output” command and reads the desired boot code from the page buffer and sends the code to the processor, thereby enabling the XIP process.

Typically the processor will request more boot code. In response to each such request, the engine 125 issues another “random data output” command. This results in the NAND device 105 shifting its column address pointer to the desired location within the page buffer and the engine 125 reading the desired boot code from the page buffer and sending it to the processor.

This XIP process is relatively slow because of latency that results from the serial nature of NAND devices. Hence, there is a need for an improved XIP implementation in NAND controllers to reduce latency in responding to boot code requests.

### SUMMARY

Embodiments of the invention described herein provide a method and system for XIP implementation in a NAND controller coupled to a NAND device. Once a random data output command is issued to the NAND device, data stored in the NAND device can be sequentially read from that column onwards to the end of the page by mere toggling of the Read Enable (RE) pin in the NAND device, thereby saving clock cycles in issuing the random data output command sequence again if the next boot read address is a continuation of the previous boot read address.

An exemplary embodiment of the invention provides a method for executing in place computer code stored in a NAND flash memory device. The method includes determining whether the boot read request form a processor is a continuation of a previous boot read request. If the boot read request is a continuation of the previous boot read request then a read enable pin in the NAND device is toggled else a random data output command sequence to the NAND device is issued.

Another exemplary embodiment of the invention provides a method for XIP implementation in a NAND controller. The method generates a lookahead address in a lookahead register by adding a boot read request to a length of boot read request data in a first boot read request operation; and compares the boot read request from the processor in subsequent boot read request operations and determines whether to generate a random data output command sequence.

An exemplary embodiment of the invention provides a system for XIP implementation in a NAND controller. The system includes an initiator sequencer in a NAND controller for providing a page load command to a predefined block and page address in a NAND device; an address tracker for identifying a boot read request received from a processor during a boot read operation; a lookahead address register for storing a lookahead address generated by the address tracker and for identifying whether the boot read request is a continuation of a previous boot read request; and a data bus interface for toggling a read enable pin in the NAND device if the boot read request is a continuation of the previous boot read request; and for sending a random data output command sequence using random data output engine to the NAND device followed by toggling the read enable pin if the boot read request is not a continuation of the previous boot read address.

Other aspects and example embodiments are provided in the Figures and the Detailed Description that follows.

### BRIEF DESCRIPTION OF THE DRAWINGS

FIG. 1 is a simplified block diagram for XIP implementation in a NAND controller according to prior art;

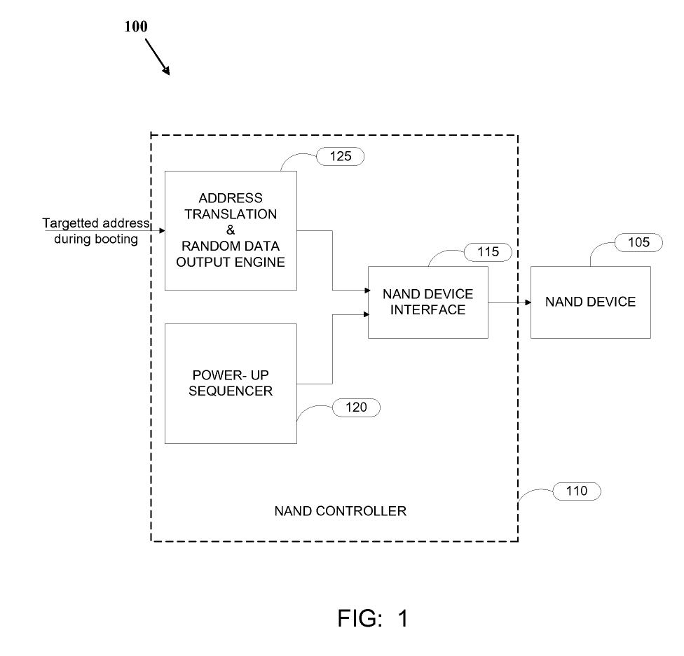

FIG. 2 is a flow diagram illustrating the steps in a method for XIP implementation in a NAND controller according to an embodiment of the invention;

FIG. 3 is a flow diagram illustrating the steps in a method for XIP implementation in a NAND controller according to another embodiment of the invention; and

FIG. 4 is a block diagram illustrating a system for XIP implementation according to an embodiment of the invention.

### DETAILED DESCRIPTION OF THE EMBODIMENTS

Embodiments of the invention described herein provide a method and system for XIP implementation in a NAND controller coupled to a NAND device.

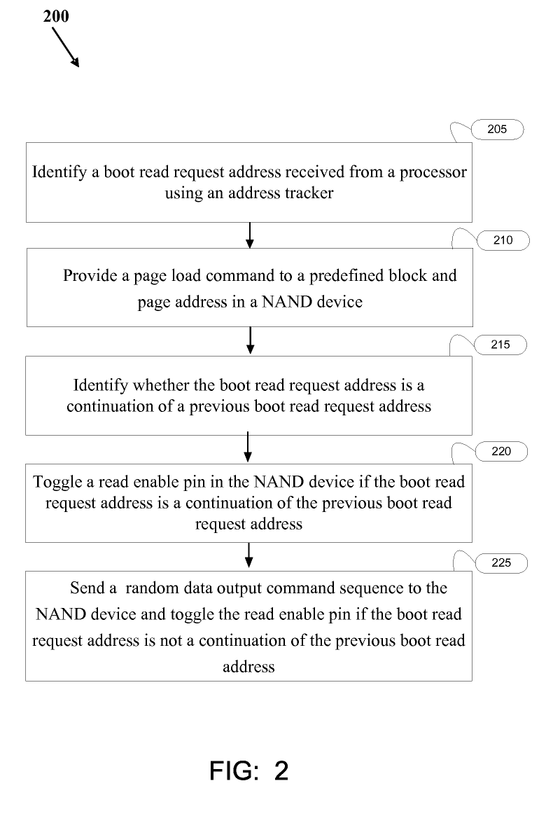

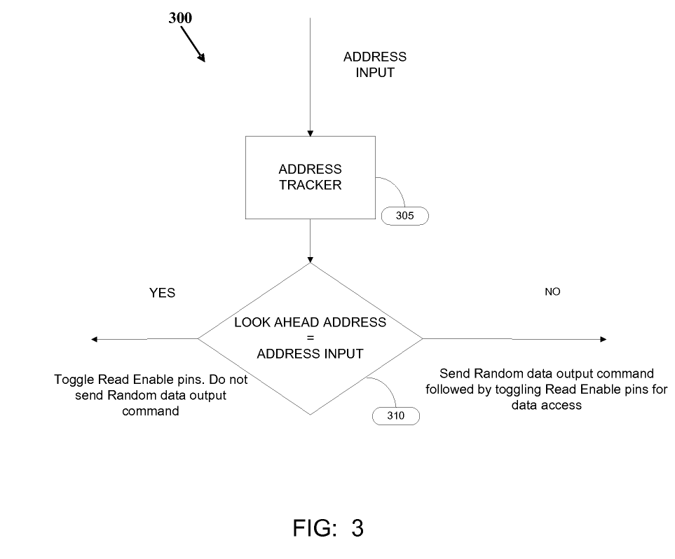

In an embodiment of the invention, generally 200 as shown in FIG. 2, a page load command is provided at step 205 to a predefined block and page address in the NAND device using a NAND controller. At step 210, a boot read request is received from a processor and is identified using an address tracker. Whether the boot read request is a continuation of a previous boot read request is identified at step 215 using a lookahead address register. The operation of lookahead register and identifying whether the boot read request is a continuation of a previous boot read request is illustrated in detail in FIG. 3.

In some embodiments of the invention, the boot read request may be identified by using the format of the boot read request command provided to the NAND controller.

If the boot read request is a continuation of the previous boot read request, a Read Enable (RE) pin in the NAND device is toggled at step 220. On the other hand, if the boot read request is not a continuation of the previous boot read address, a random data output command sequence is sent at step 225 to the NAND device using a random data output engine and the RE pin is toggled. By toggling the RE pin the NAND controller accesses the data from the NAND device and sends the data to the processor. Each time when the RE pin is toggled, subsequent data stored in the NAND device is returned to the processor.

In some embodiments of the invention, at step 220 it may be decided not to send the random data output command sequence to the NAND device.

In some embodiments of the invention, a lookahead address is generated in a lookahead register. The lookahead address is generated by adding the boot read request from the processor to the length of the boot read request data in the first boot read request operation in the NAND controller. The lookahead address is stored in a lookahead register in the NAND controller. Subsequent read operations compare the incoming boot read request with the lookahead address to decide on whether to continue with the random data output command sequence or to directly read the data form the NAND device by toggling the RE pin.

The method described above includes different steps involved in XIP implementation in a NAND controller. The method may include a greater or a fewer number of steps than those included in FIG. 2.

As shown in FIG. 3, in some embodiments an address tracker 305 generates the lookahead address. The lookahead address is updated during each boot read request operation by the address tracker 305. The lookahead address is then compared (310) to the boot read request from the processor in subsequent boot read request operations and determines whether to generate a random data output command sequence from the NAND controller. In some embodiments, if the lookahead address and the boot read request data address are the same, the bus interface in the NAND controller is instructed to toggle the RE pin and not to send the random output data sequence. If the lookahead address and the boot read request data address are different, the random data output command sequence is sent to the NAND device and the bus interface of the NAND controller is instructed to toggle the RE pin. Once a random data output command is issued to the NAND device, data stored in the NAND device can be sequentially read from that column onwards to the end of the page by mere toggling of the RE pin in the NAND device, thereby saving clock cycles in issuing the random data output command sequence again if the next boot read address is a continuation of the previous boot read address.

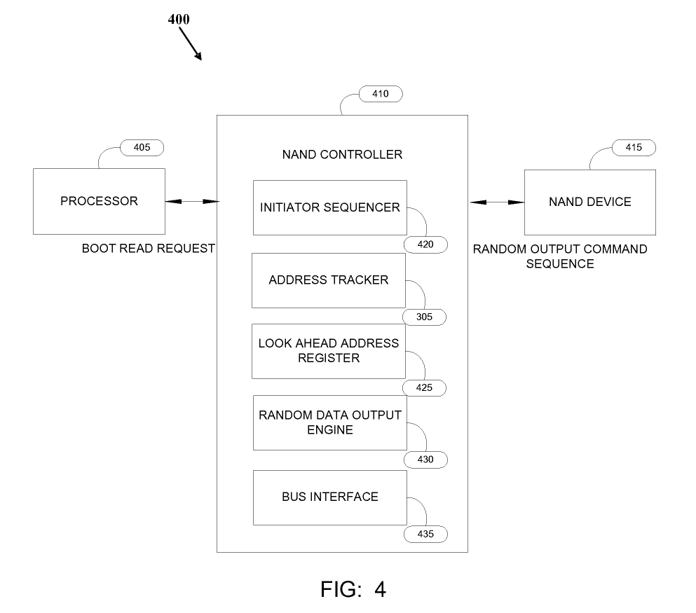

A system for XIP implementation according to an embodiment of the invention is shown in FIG. 4. The system 400 generally includes a NAND device 415 coupled to a processor 405 through a NAND controller 410. The NAND controller 410 includes an initiator sequencer 420, an address tracker 305 as previously described with reference to FIG. 3, a lookahead address register 425, a random data output engine 430 communicating with each other and a bus interface 435. During power-up of the NAND controller 410, the desired boot code is read from a predefined block and page address in the NAND device 415. The initiator sequencer 420 issues a page load command to this predefined block and page address. The address tracker 305 identifies a boot read request received from the processor 405 during the boot read operation to the NAND controller 410. The Address tracker 305 also identifies a boot read request from the format of command address provided to the NAND controller 410. Also, the address tracker 305 receives address order information (whether address in serial order or in random order) from the lookahead register 425. Using this information, address tracker 305 can decide whether to send the random data output command sequence.

The lookahead register 425 stores a lookahead address generated by the address tracker 305 and identifies whether the boot read request is a continuation of a previous boot read request. According to random data output code generation conditions as explained in FIG. 3, the random data output engine 430 of the NAND controller 410 generates the random data output command sequence and sends it to the NAND device 415 when required. Also, when a toggling of the RE pin is required, a logic component of the NAND controller 410 named bus interface 435 is instructed to read data serially from the NAND device 415 by toggling the RE pin of the NAND device 415 from a first level to a second level such as high to low, and then from the second level back to the first level, such as low to high.

System 400 described above may include a greater or a fewer number of modules than those included in FIG. 4.

The serially reading of the data reduces latency by saving clock cycles by not issuing the random data output command sequence again if the next boot read request is a continuation of the previous boot read request.

The forgoing description sets forth numerous specific details to convey a thorough understanding of the invention. However, it will be apparent to one skilled in the art that the invention may be practiced without these specific details. Well-known features are sometimes not described in detail in order to avoid obscuring the invention. Other variations and embodiments are possible in light of above teachings, and it is thus intended that the scope of invention not be limited by this Detailed Description, but only by the following Claims

What is claimed is:

1. A method of executing in place computer code stored in a NAND flash memory device comprising:
determining whether a boot read request from a processor is a continuation of a previous boot read request;
if the boot read request is a continuation of the previous boot read request, toggling a read enable pin in the NAND device, and
if the boot read request is not a continuation of the previous boot read request, issuing a random data output command sequence to the NAND device.

2. The method of claim 1 further comprising:
identifying the boot read request contained in a read request command; and
deciding to send said random data output command sequence based on the relationship between the identified boot read request and a previous read request.

3. The method of claim 1, wherein said toggling comprises changing said read enable pin value in the NAND device from a first level to a second level followed by the second level back to the first level and reading data serially from the NAND device.

4. The method of claim 1 further comprising updating a lookahead register during each boot read request operation.

5. An execute-in-place method comprising:
generating a lookahead address in a lookahead register by adding a boot read request from a processor to a length of boot read request data in a first boot read request operation in a NAND controller; and
comparing a boot read request from said processor in a subsequent boot read request operation to the lookahead register and determining whether to generate a random data output command sequence from said NAND controller.

6. The execute-in-place method of claim 5, wherein said comparing comprises:
providing a page load command for accessing a predefined block and page address in a NAND device;
identifying whether the boot read request is equal to said lookahead address;
toggling a read enable pin in the NAND device if the boot read request and the lookahead address are same; and
sending said random data output command sequence to the NAND device followed by toggling said read enable pin if the boot read request and the lookahead address are different.

7. The execute-in-place method of claim 6, wherein said identifying comprises:
identifying the boot read request contained in a read request command; and
deciding to send said random data output command sequence based on the relationship between the identified boot read request and a previous read request.

8. The execute-in-place method of claim 6, wherein the predefined block and page address comprises a boot read request.

9. The execute-in-place method of claim 6, wherein said toggling comprises changing said read enable pin value in the NAND device from a first level to a second level followed by the second level back to the first level and reading data serially from the NAND device.

10. The execute-in-place method of claim 6 further comprising updating the lookahead register during each boot read request operation.

11. An execute-in-place NAND controller responsive to a processor to control a NAND device, the NAND controller comprising:
an initiator sequencer for providing a page load command to a predefined block and page address in the NAND device;
an address tracker for identifying a boot read request received from said processor during a boot read operation;
a lookahead address register for storing a lookahead address generated by said address tracker and for identifying whether said boot read request is a continuation of a previous boot read request; and
a data bus interface for toggling a read enable pin in the NAND device if the boot read request is a continuation of said previous boot read request and for sending a random data output command sequence using a random data output engine to the NAND device followed by toggling said read enable pin if the boot read request is not a continuation of the previous boot read address.

12. The execute-in-place NAND controller of claim 11, wherein the address tracker identifies a boot read request from a format of command address.

13. The execute-in-place NAND controller of claim 11, wherein the lookahead register provides address order information having both serial and random components to the address tracker.

14. The execute-in-place NAND controller of claim 11, wherein said lookahead address is updated during each of said boot read operations.
